(19) United States
(12) Patent Application Publication
(10) Pub. No.: US 2019/0176442 A1
(43) Pub. Date: Jun. 13, 2019

(54) PACKAGING FILMS FOR ULTRASONIC SEALING APPLICATIONS

(71) Applicant: Bemis Company, Inc., Neenah, WI (US)

(72) Inventors: Melissa Kanzelberger Coolich, Hortonville, WI (US); Emily M. Gasteyer, Naperville, IL (US)

(21) Appl. No.: 16/310,263

(22) PCT Filed: Jun. 16, 2016
(86) PCT No.: PCT/US16/37797

§ 371 Date: Dec. 14, 2018

(51) Int. Cl. B32B 27/08; B32B 27/32; B32B 17/10; B32B 27/34

(52) U.S. Cl. CPC B32B 27/08; B32B 27/32; B32B 2553/00; B32B 27/34; B32B 2307/7244; B32B 17/1055

(57) ABSTRACT

The present invention is directed to delamination-resistant ultrasonic sealant films for packaging food, medical and/or pharmaceutical products having seals formed by ultrasonic sealing methods. The films according to the present invention have at least a sealant layer comprising a first propylene-ethylene copolymer and a second propylene-ethylene copolymer, a tie layer comprising at least one of the first or second propylene-ethylene copolymers of the sealant layer, and a barrier layer adjacent to the tie layer. The films according to the present invention may be used in aseptic, hot-fill and/or retort packaging applications.

### BACKGROUND OF THE INVENTION

The present invention relates generally to primary packaging for food, medical device and pharmaceutical products, and in particular to multilayer packaging films which have barrier properties and when sealed together by ultrasonic energy do not delaminate.

It is common practice in packaging many goods, including food items, to use what is generally known as form-fill-seal equipment. For example, in the vertical form-fill-seal (VFFS) arrangement, flexible plastic film is fed from a roll-stock to a tube former where a tube is fashioned from the film into a vertically dependent, upwardly open tube having overlapping longitudinal edges. These overlapping edges are subsequently sealed together longitudinally forming a back-seam, and the end of the tube is sealed together by a pair of transverse heat-seals which are vertically spaced apart. Typically, a lap-type or butt-type configuration is used to form the longitudinal back-seam of the package, and a fin-type configuration used form the transverse seals. At this point, the tube is filled with a measured quantity of the product to be packaged. Often, the packaging material may be squeezed in some cases as with liquids or slurries so that the air in the headspace of the pouch is eliminated. Shortly thereafter, another sealing operation, typically performed after the filled tube has been downwardly advanced, completes enclosure of the product. In these sealing operations, a thermal-based or adhesive glue-based sealing process may be used to affix the packaging material to itself. Typically during a thermal-based sealing process, the packaging material is forced together under heat and pressure. The terms “heat-seal” and “heat sealing” are used interchangeably hereinafter and are well-known in the arts. Heat-seals of a vertical form-fill-seal package must have sufficient seal strength in order to resist the physical and mechanical abuse imposed by the relatively fast-moving sealing process.

In order to store some foods without refrigeration, a product may be packaged in barrier materials which prevent the ingress of oxygen and moisture. Non-limiting examples of oxygen barrier materials include plastics such as polyamides (nylon), ethylene vinyl alcohol copolymers, polyvinyl chlorides, polyvinylidene chlorides, metallic coatings and foils, and glasses. Moisture barrier materials may include, but are not limited to, polyethylene terephthalate copolymers, ethylene norbornene copolymers and high density polyethylenes. Some plastics such as ethylene norbornene copolymers may have both moisture and chemical barrier properties.

Quite often, oxygen sensitive foods are sterilized by a hot-fill or aseptic operation during packaging process, or a retort operation after the product is packaged. Sterilization by these operations imposes several severe restrictions on the choice of plastic film for the package. The oxygen and moisture barrier properties of the packaging material must not be adversely affected by the conditions of sterilization. Most importantly, the seals of the package need to have sufficient seal strength to resist the shearing and/or compression forces resulting from the relatively high temperatures and pressures during the sterilization process. For example, seals must survive sterilization temperatures of over 71° C. (160° F.) or typical retort conditions of steam or water at 121° C. (250° F.) or more under pressure for one half hour or more.

While thermal-based and adhesive glue-based sealing processes dominate the packaging industry, an alternative sealing method involves ultrasonic welding or ultrasonic sealing. Ultrasonic welding is an alternative sealing technology based on high frequency acoustic vibrations. Generally, this method works by generating a very high voltage and converting that into high frequency vibrations. The high frequency vibrations lead to interfilm and intermolecular friction within a defined seal area of the packaging material. Heat generated by this friction seals the packaging surfaces together.

During a typical ultrasonic welding process, ultrasonic energy is applied to the two film surfaces between an ultrasonically activated horn and a stationary or rotary anvil. A typical ultrasonic horn is made of a metallic material having good acoustic qualities, such as aluminum or titanium. A typical anvil is also made of metallic material such as steel or aluminum and is positioned in opposition to the ultrasonic horn. Ultrasonic vibration in the horn is typically produced by supplying oscillatory electrical energy from an external power supply to an electromechanical transducer or converter, such as a piezoelectric crystal, which transforms the electrical energy into mechanical vibration. Typically, the mechanical vibration is then amplified by an amplitude transformer, or booster, to a predetermined operational amplitude. The booster is typically directly connected to the ultrasonic horn and supplies the ultrasonic vibration employed by the ultrasonic horn. Typically, the ultrasonic horn vibrates at between 20 KHz and 40 KHz. Ultrasonic welding equipment and methods are well-known in the arts.

Ultrasonic welding has become an attractive means for sealing packages for a number of reasons. Most importantly, ultrasonic welding permits sealing through contaminants and product in the sealing area, which the conventional thermal-based and adhesive glue-based sealing processes accomplish poorly, if at all. This allows the formation of excellent seal strengths even when packaged material contaminates the seal area.

Another benefit of ultrasonic welding relates to a saving in raw material costs. When forming a seal between film surfaces using conventional heat sealing, the packaging surfaces may overlap by as much as 10 mm. Much of this overlap is therefore wasted film. With ultrasonic welding this overlap can be reduced to 6 mm. In the context of thousands of packages per hour, that adds up to a significant reduction in waste. Ultrasonic sealing reduces the necessary material, by allowing for a narrower weld, while also simultaneously producing welds of improved durability, which is highly desirable particularly for the packaging of bulk liquid, semi-liquid, and even for the packaging of solids or semi solid products. Of course, the process could still be used to produce wider welds, where they may be desired, for example for aesthetic purposes, rather than for being needed to produce a stronger, more durable seal. Consequently, ultrasonic welding is becoming more popular as a technique for sealing packaging materials.

Unfortunately, the use of ultrasonic sealing has been limited to monolayer plastic films and laminated structures because coextruded films having two or more plastic layers often delaminate during ultrasonic sealing process. Thus, the need remains for multilayer packaging films which have sufficient barrier properties and can withstand the ultrasonic welding process without delaminating.

### SUMMARY OF THE INVENTION

It has been discovered that the ultrasonic sealing process induces delamination between the tie layer and adjacent barrier layer in multilayer coextruded films. Therefore, it is an object of the present invention to provide a multilayer delamination-resistant sealant film having a sealant layer, a tie layer and a barrier layer which exhibits no delamination between the tie and barrier layers after the sealant layer is sealed to itself or another polyolefin substrate by ultrasonic energy. It is within the scope of the present invention for the multilayer delamination-resistant sealant film to include any number of additional layers as needed depending upon the requirements of a particular packaging application. These additional layers may include, but are not limited to oxygen barrier layers, moisture barrier layers, chemical barrier layers, abuse layers, tie or adhesive layers, bulk layers, and odor and oxygen scavenging layers.

It is another object of the present invention to provide a multilayer delamination-resistant sealant film for packaging food, medical and/or pharmaceutical products in an aseptic package having seals formed by ultrasonic sealing methods.

It is another object of the present invention to provide a multilayer delamination-resistant sealant film for packaging food products in a hot-fill package having seals formed by ultrasonic sealing methods.

It is another object of the present invention to provide a multilayer delamination-resistant sealant film for packaging food products in a retort pouch having seals formed by ultrasonic sealing methods.

It is another object of the present invention to provide a multilayer sealant film for packaging liquids in a vertical and/or horizontal form-fill-seal package format having seals formed by ultrasonic sealing methods.

The aforementioned objectives as well as others are achieved by a multilayer film having at least a sealant layer comprising a first propylene-ethylene copolymer and a second propylene-ethylene copolymer, a tie layer comprising at least one of the first or second propylene-ethylene copolymers of the sealant layer, and a barrier layer adjacent to the tie layer and comprising a material selected from the groups consisting of polyamide, ethylene vinyl alcohol copolymer, polyvinyl chloride, polyvinylidene chloride, glass, thermoplastic polyurethane, polyethylene terephthalate copolymer and blends thereof.

For purposes of this disclosure, the term “propylene-ethylene copolymer” refers to copolymers comprising two types of monomers, between 51 and 99% by weight of propylene and between 1 and 49% by weight of ethylene relative to the total weight of the propylene-ethylene copolymer. It should be understood that the propylene-ethylene copolymers referred to herein may include random, block and/or grafted copolymers, and may include more than two repeating components wherein the dominant monomer is propylene. Those skilled in the art will appreciate that propylene-ethylene copolymers are distinctly different than propylene homopolymers which do not include a different monomer other than propylene. Propylene-ethylene copolymers are also distinctly different that ethylene-propylene copolymers because ethylene-propylene copolymers are ethylene-based rather than propylene-based copolymers.

### BRIEF DESCRIPTION OF THE DRAWINGS

Further features and advantages of the present invention will become apparent from the following detailed description, taken in combination with the appended drawings, in which:

FIG. 1 illustrates a schematic of one preferred embodiment of a delamination-resistant ultrasonic sealant film according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The films of the present invention may be fabricated by several different conventional methods known in the art including blown film coextrusion, slot cast coextrusion, extrusion lamination, extrusion coating and combinations thereof. In a preferred embodiment, the multilayer interior film was produced using a coextrusion blown film line. In this method, the line was equipped with multiple extruders which fed into a multi-manifold circular die head through which the film layers are forced and formed into a cylindrical multilayer film bubble. The bubble was quenched, then collapsed and formed into a multilayer film. Films produced using blown film processes are known in the art and have been described, for example, in The Encyclopedia of Chemical Technology, Kirk-Othmer, 3rd ed., John Wiley & Sons, New York, 1981, Vol. 16, pp. 416-417 and Vol. 18, pp. 191-192, the disclosures of which are incorporated herein by reference. Typically, the resins and any additives forming one or more film layers were introduced to an extruder where the resins were melt-plastified by heating and then transferred to an extrusion (or coextrusion) die for formation into the bubble or tube. If desired, resins may be blended or mechanically mixed by well-known methods using commercially available equipment including tumblers, mixers or blenders, and well-known additives such as processing aids, slip agents, anti-blocking agents, pigments and mixtures thereof may be incorporated into the resin by blending prior to extrusion. The extruder and die temperatures will generally depend upon the particular resin(s) containing mixtures being processed, and suitable temperature ranges for commercially available resins are generally known in the art or are provided in technical bulletins made available by resin manufacturers.

The specific conditions for operation of any specific extrusion equipment can be readily determined by one skilled in the art. After formation, the bubble is cooled, collapsed, slit, and wound around a roller for further processing.

### Sealant Layer

The sealant layer of the present invention is designed specifically for ultrasonic sealing to itself or another polyolefin by selecting a first propylene-ethylene copolymer and a second propylene-ethylene copolymer such that the difference between flexural modulus of each propylene-ethylene copolymer is at least 25,000 psi, at least 50,000 psi, at least 75,000 psi, or at least 100,000 psi as measured at 0.05 in/min (0.127 cm/min), 1% secant in accordance with ASTM D-790 test method. These two different propylene-ethylene copolymers are then dry or melt blended together alone or with other materials to form the sealant layer composition. In some preferred embodiments, the first propylene-ethylene copolymer has a flexural modulus at 0.05 in/min (0.127 cm/min), 1% secant of between 2,000 and 100,000 psi as measured in accordance with ASTM D-790 test method. In such embodiments, the first propylene-ethylene copolymer may be present in an amount of between 10 sand 45% by weight relative to the total weight of the sealant layer. In other such embodiments, the first propylene-ethylene copolymer may be present in an amount of between 25 and 65% by weight relative to the total weight of the sealant layer. In some preferred embodiments, the second propylene-ethylene copolymer has a flexural modulus at 0.05 in/min (0.127 cm/min), 1% secant of between 101,000 and 300,000 psi as measured in accordance with ASTM D-790 test method. In such embodiments, the second propylene-ethylene copolymer may be present in an amount of between 10 and 90% by weight relative to the total weight of the sealant layer. In other such embodiments, the second propylene-ethylene copolymer may be present in an amount of between 25 and 65% by weight relative to the total weight of the sealant layer. It is also contemplated that the sealant layer may further include a first polyethylene copolymer and/or a second polyethylene copolymer. In some preferred embodiments, the first polyethylene copolymer is a polyethylene block copolymer. A non-limiting example of a suitable polyethylene block copolymer has a tensile modulus at 100% secant of between 100 and 500 psi as measured in accordance with ASTM D-638 test method. In some preferred embodiments, the second polyethylene copolymer is a metallocene ethylene-hexene copolymer. In these preferred embodiments, the first and/or second polyethylene copolymer is present in an amount of between 1 and 35% by weight relative to the total weight of the sealant layer. It is further contemplated that the sealant layer has a thickness of at least 13% relative to the total thickness of the film.

### Tie Layer

The tie layer of the present invention includes at least one of the first or second propylene-ethylene copolymers of the sealant layer. In some preferred embodiments, the tie layer comprises at least one of the first or second propylene-ethylene copolymers of the sealant layer and an anhydride modified polyolefin. In such embodiments, the anhydride modified polyolefin may be an anhydride modified propylene-ethylene copolymer or an anhydride modified polyethylene copolymer. In some preferred embodiments, the anhydride modified polyethylene copolymer is a maleic anhydride grafted linear low density polyethylene with a level of maleic anhydride grafted onto the linear low density polyethylene of greater than 0.5% by weight relative to the total weight of the copolymer. It is also contemplated that the tie layer may further include an unmodified polyethylene. In some preferred embodiments, the unmodified polyethylene is a high density polyethylene or an ethylene norbornene copolymer. In some preferred embodiments, the tie layer is adjacent to the sealant layer. In other preferred embodiments, the tie layer is separated from the sealant layer by one or more bulk layers. It is further contemplated that the tie layer has a thickness of at least 16% of the total film thickness. In such embodiments, the tie layer has a thickness of between 16 and 40% relative to the total thickness of the film.

It is within the scope of the present invention that while propylene-ethylene copolymer used in the tie layer has the same range of flexural modulus at 0.05 in/min (0.127 cm/min), 1% secant as that of the propylene-ethylene copolymer used in the sealant layer, other physical and/or chemical properties between these two copolymers may be different. Such differences may include but are not limited to different melt indexes, different specific gravities, different melting temperatures, or the ratio of propylene to ethylene repeating units in the copolymer.

### Barrier Layer

The barrier layer of the present invention is positioned adjacent to the tie layer. In some preferred embodiments, the barrier layer comprises at least one material selected from the group consisting of polyamide, ethylene vinyl alcohol copolymer, polyvinyl chloride, polyvinylidene chloride, glass, thermoplastic polyurethane, polyethylene terephthalate copolymer and blends thereof. It is within the scope of the present invention that other barrier materials suitable may be used other than the aforementioned materials. In some preferred embodiments, the barrier layer is an oxygen barrier and consists essentially of polyamide or blend of polyamide resins. In other preferred embodiments, the barrier layer is an oxygen barrier and consists essentially of ethylene vinyl alcohol copolymer.

It should be understood that the term “delamination resistant” used herein refers to film structures which exhibit no visible delamination between the tie and barrier layers after the film has been ultrasonically sealed to itself or another film. In some preferred embodiments, delamination resistant may also correspond to films having seal strengths of 1.93 N/mm (11 lb./in) or higher after the film has been ultrasonically sealed to itself or another film. In such embodiments, the seal strength of the film may be greater than the tensile strength of one or more of the materials used to form the film.

### Working Examples

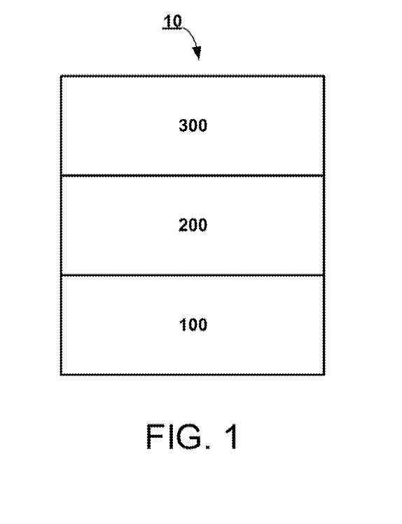

FIG. 1 illustrates one preferred embodiment of a delamination-resistant ultrasonic sealant film according to the present invention. In this drawing, film 10 comprises at least a sealant layer 100, a tie layer 200, and a barrier layer 300.

In the following examples, the sealant layer 100, tie layer 200 and barrier layer 300 were coextruded together using a slot cast die and single-screw extruder. The total thickness of the films 100 was approximately between 114.3 and 177.8 μm (4.5 and 7 mil). The individual layer thicknesses ranged from 57.17 and 88.9 μm (2.25 and 3.5 mil).

Reported below in TABLE 1 are various sealant layer and tie layer formulations. In each example, the barrier layer was 100 wt. % nylon 6 having melting point temperature of 220° C. and a density of 1.13 g/cm³. A commercial example of a nylon 6 having these properties is sold under the trademark Ultramid® B36 01 by BASF Polyamides and Intermediates, Freeport, Tex.

To demonstrate the efficiency of the sealant and tie layer formulations in reducing and/or eliminating delamination between the tie and barrier layers, the seal strengths were measured after the film was ultrasonically sealed to itself (sealant layer-to-sealant layer). The films were ultrasonically sealed using a 30 kHz Herrmann ultrasonic unit (Herrmann Ultrasonics, Bartlett, Ill.) with a DDc generator. Two different energy levels were used to evaluate each sealant film samples, at 100 and 125 Joules. At each energy level, the ultrasonic process included a hold time of 0.25 seconds, an amplitude of 90%, a trigger force of 40 lb.-f, and a weld force of 50 lb.-f. The results for both energy levels were averaged together. If tensile failure was observed during the seal strength measurement, the film was rated with a “+” sign. If the seal strength was at least 1.93 N/mm (11 lb./in) or higher, the film was rated with a “±” sign. If the seal strength was less than 1.93 N/mm (11 lb./in), the film was rated with a “−” sign. The results are reported below in TABLE 1.

TABLE 1

| | SEALANT LAYER FORMULATION | | | | TIE LAYER FORMULATION | | | |
|---|---|---|---|---|---|---|---|---|
| Ex. | Component 1 | Component 2 | Component 3 | Component 4 | Component 1 | Component 2 | Component 3 | SCORE |
| 1 | 100% PP-PE₁ | | | | 100% mah-PP | | | − |
| 2 | 85-90% PP-PE₁ | 10-15% PE₁ | | | 100% mah-PP | | | − |
| 3 | 28% PP-PE₁ | 72% PP-PE₂ | | | 100% mah-PP | | | − |
| 4 | 28% PP-PE₁ | 72% PP | | | 100% mah-PP | | | − |
| 4 | 50 PP-PE₁ | 50% PE₂ | | | 100% mah-PP | | | − |
| 5 | 90% PP | 10% PE₁ | | | 100% mah-PP | | | − |
| 6 | 80% PE₂ | 20% PE₁ | | | 100% mah-PP | | | − |
| 7 | 30-80% PP-PE₁ | 5-55% PE₂ | 15% PE₃ | | 100% mah-PP | | | + |
| 8 | 60-70% PP-PE₁ | 15-25% PE₂ | 15% PE₃ | | 100% mah-PP | | | ± |
| 9 | 28% PP-PE₁ | 57% PP | 25% PP-PE₃ | | 100% mah-PP | | | − |
| 10 | 28% PP-PE₁ | 57-62% PP-PE₂ | 10-15% PE₄ | | 100% mah-PP | | | ± |
| 11 | 55% PP-PE₁ | 15% PE₂ | 15% PE₃ | 5% PE₁ | 100% mah-PP | | | − |
| 12 | 28% PP-PE₁ | 52% PP-PE₂ | 15% PE₄ | 5% PE₂ | 100% mah-PP | | | + |
| 13 | 30% PP-PE₁ | 55% PE₂ | 15% PE₄ | | 50% mah-PE | 50% PP-PE₂ | | ± |
| 14 | 30% PP-PE₁ | 55% PE₂ | 15% PE₄ | | 50% mah-PE | 40% PP-PE₂ | 10% PE₁ | + |
| 15 | 30% PP-PE₁ | 55% PE₂ | 15% PE₄ | | 50% mah-PE | 40% PP-PE₁ | 10% PE₁ | − |
| 16 | 100% PP-PE₁ | | | | 50% mah-PE | 40% PP-PE₁ | 10% PE₁ | − |
| 17 | 100% PP-PE₂ | | | | 50% mah-PE | 40% PP-PE₁ | 10% PE₁ | − |
| 18 | 50% PP-PE₂ | 25% PP-PE₁ | 25% PE₂ | | 50% mah-PE₁ | 40% PP-PE₁ | 10% PE₁ | + |
| 19 | 50% PP-PE₂ | 25% PP-PE₁ | 25% PE₂ | | 50% mah-PE₁ | 40% PP-PE₁ | 10% PE₁ | + |
| 20 | 50% PP-PE₂ | 25% PP-PE₁ | 15% PE₄ | 10% PE₂ | 50% mah-PE | 40% PP-PE₁ | 10% PE₁ | + |
| 28 | 50% PP-PE₂ | 25% PP-PE₁ | 15% PE₅ | 10% PE₂ | 50% mah-PE | 40% PP PE₁ | 10% PE₂ | ± |

PP-PE₁=1^{st} Polypropylene/Ethylene copolymer having a flexural modulus at 0.05 in/min (0.127 cm/min), 1% secant of between 2,000 and 100,000 psi as measured in accordance with ASTM D-790 test method. Non-limiting commercially available examples include such polypropylene/ethylene copolymers such as those sold under the trademark VERSIFY™ 2000 and 3000 by The Dow Chemical Company, Inc., Midland, Mich. The VERSIFY™ 2000 copolymer has a density of 0.89 g/cm³, a total crystallinity of 35% and a flexural modulus (1% secant) of 52,000 psi as measured according to ASTM test method D-790. The VERSIFY™ 3000 copolymer has a density of 0.89 g/cm³, a total crystallinity of 44% and a flexural modulus (1% secant) of 56,500 psi as measured according to ASTM test method D-790.

PP-PE₂=2^{nd} Polypropylene/Ethylene copolymer having a flexural modulus at 0.05 in/min (0.127 cm/min), 1% secant of between 101,000 and 100,000 psi as measured in accordance with ASTM D-790 test method. Non-limiting commercially available examples include polypropylene/ethylene copolymers such as LyondellBasell Pro-fax SA861 random polypropylene supplied by LyondellBasell, Houston, Tex. and Braskem PP RP 650 random polypropylene supplied by Braskem America Inc., Philadelphia, Pa. The LyondellBasell Pro-fax SA861 copolymer has a density of 0.90 g/cm³, a melt flow of 6.5 g/10 min, and a flexural modulus (1% secant at 0.05 in/min) of 133,000 psi as measured according to ASTM test method D-790. The Braskem PP RP 650 copolymer has a melt flow rate of 2.0 g/10 min (230° C./2.16 kg) and a flexural modulus (1% secant at 0.05 in/min) of 170,000 psi as measured according to ASTM test method D-790.

PP-PE₃=3^{rd} Polypropylene/Ethylene copolymer which is an amorphous polypropylene/ethylene copolymer sold under the trademark Eastoflex™ E1060PL and supplied by Eastman Chemical Company, Inc., Kingsport, Tenn.

PE₁=High density polyethylene (HDPE). A non-limiting commercially available example of such a material includes LyondellBasell Alathon® M6020 supplied by LyondellBasell, Houston, Tex. which has a density of 0.96 g/cm³ and a melting temperature of between 199-210° C.

PE₂=Olefin block copolymer. A non-limiting commercially available example of such a material includes INFUSE™ 9530 supplied by The Dow Chemical Company, Inc., Midland, Mich. which has a specific gravity of 0.889, and melt flow rate of 5.0 g/10 min, and a melting temperature of 118.9° C.

PE₃=Metallocene ethylene-hexene very low density polyethylene (VLDPE). Metallocene VLDPE may have a density of between 0.912 and 0.918 g/cm³, a melt index of between 1.0 and 3.5 g/10 min, and a peak melting temperature of between 114° and 117° C. Non-limiting commercially available examples of such materials include Exceed™ 1012 and 3812 series of VLDPE polymers supplied ExxonMobil Chemical Company, Inc., Houston, Tex.

PE₄=Linear low density polyethylene (LLDPE). A specific non-limiting commercially available examples of a suitable LLDPE includes DOWLEX™ 2045G having a specific gravity of 0.922, a melt flow rate of 1.0 g/10 min, and a melting temperature of 118.9° C. which can be obtained from The Dow Chemical Company, Inc., Midland, Mich.

PE₅=Metallocene ethylene-hexene linear low density polyethylene (LLDPE). A non-limiting commercially available example of such a material includes Exceed™ 3518 series of polymers which have a density of 0.918 g/cm³, a melt index of 3.5 g/10 min, and a peak melting temperature of 114° C. The Exceed™ 3518 series of LLDPE polymers can be obtained from ExxonMobil Chemical Company, Inc., Houston, Tex.

PP=Heterophasic polypropylene copolymer or polypropylene impact copolymer. A non-limiting commercially available example of such a material includes Inspire 114 Performance Polymer EU having a density of 0.9 g/cm³, and a melt flow rate (230° C./2.16 kg) of 0.5 g/10 min which can be obtained from The Dow Chemical Company, Inc., Midland, Mich.

mah-PP=Maleic anhydride grafted polypropylene homopolymer. A non-limiting commercially available example of such a material includes AMPLIFY™ TY 2551 having a density of 0.896 g/cm³, a melt index of 5 g/10 min, a melting temperature of between 221 to 238° C., and a maleic anhydride graft level of less than 0.25 wt. %. This material may be obtained from The Dow Chemical Company, Midland, Mich.

mah-PE=Maleic anhydride grafted polyethylene. A non-limiting commercially available example of such a material includes AMPLIFY™ TY 1052H having a density of 0.875 g/cm³, a melt index (190° C./2.16 kg) of 1.3 g/10 min, a melting temperature of 62.8° C., and a maleic anhydride graft level of greater than 0.5 wt. %. This material may be obtained from The Dow Chemical Company, Midland, Mich.

The above test results indicate optimal delamination-resistance for ultrasonic sealing was achieved with a film having sealant layer comprising a first propylene-ethylene copolymer and a second propylene-ethylene copolymer with the first propylene-ethylene copolymer having a flexural modulus at 0.05 in/min (0.127 cm/min), 1% secant of between 2,000 and 100,000 psi and the second propylene-ethylene copolymer has a flexural modulus at 0.05 in/min (0.127 cm/min), 1% secant of between 101,000 and 300,000 psi, and with a tie layer comprising at least one of the first or second propylene-ethylene copolymers of the sealant layer.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

1. A delamination-resistant ultrasonic sealant film comprising:
a sealant layer comprising a first propylene-ethylene copolymer and a second propylene-ethylene copolymer;
a tie layer comprising at least one of the first or second propylene-ethylene copolymers of the sealant layer; and
a barrier layer contacting the tie layer and comprising a material selected from the groups consisting of polyamide, ethylene vinyl alcohol copolymer, polyvinyl chloride, polyvinylidene chloride, glass, thermoplastic polyurethane, polyethylene terephthalate copolymer and blends thereof.

2. The delamination-resistant ultrasonic sealant film according to claim 1, wherein the first propylene-ethylene copolymer has a flexural modulus at 0.05 in/min (0.127 cm/min), 1% secant of between 2,000 and 100,000 psi as measured in accordance with ASTM D-790 test method.

3. The delamination-resistant ultrasonic sealant film according to claim 1, wherein the first propylene-ethylene copolymer is present in an amount of between 10 and 90% by weight relative to the total weight of the sealant layer.

4. The delamination-resistant ultrasonic sealant film according to claim 1, wherein the first propylene-ethylene copolymer is present in an amount of between 10 and 45% by weight relative to the total weight of the sealant layer.

5. The delamination-resistant ultrasonic sealant film according to claim 1, wherein the second propylene-ethylene copolymer has a flexural modulus at 0.05 in/min (0.127 cm/min), 1% secant of between 101,000 and 300,000 psi as measured in accordance with ASTM D-790 test method.

6. The delamination-resistant ultrasonic sealant film according to claim 1, wherein the second propylene-ethylene copolymer is present in an amount of between 10 and 90% by weight relative to the total weight of the sealant layer.

7. The delamination-resistant ultrasonic sealant film according to claim 1, wherein the second propylene-ethylene copolymer is present in an amount of between 25 and 65% by weight relative to the total weight of the sealant layer.

8. The delamination-resistant ultrasonic sealant film according to claim 1, wherein the sealant layer further comprises a first polyethylene copolymer and/or a second polyethylene copolymer.

9. The delamination-resistant ultrasonic sealant film according to claim 8, wherein the first polyethylene copolymer is a polyethylene block copolymer.

10. The delamination-resistant ultrasonic sealant film according to claim 9, wherein the polyethylene block copolymer has a tensile modulus at 100% secant of between 100 and 500 psi as measured in accordance with ASTM D-638 test method.

11. The delamination-resistant ultrasonic sealant film according to claim 8, wherein the second polyethylene copolymer is a metallocene ethylene-hexene copolymer.

12. The delamination-resistant ultrasonic sealant film according to claim 8, wherein each of the first and/or second polyethylene copolymers is present in an amount of between 1 and 35% by weight relative to the total weight of the sealant layer.

13. The delamination-resistant ultrasonic sealant film according to claim 1, wherein the tie layer further comprises an anhydride modified polyethylene and an unmodified polyethylene.

14. The delamination-resistant ultrasonic sealant film according to claim 13, wherein the unmodified polyethylene is a high density polyethylene or an ethylene norbornene copolymer.

15. The delamination-resistant ultrasonic sealant film according to claim 13, wherein the anhydride modified polyolefin is a maleic anhydride grafted linear low density polyethylene with a level of maleic anhydride grafted onto the linear low density polyethylene of greater than 0.5% by weight relative to the total weight of the copolymer.

16. The delamination-resistant ultrasonic sealant film according to claim 1, wherein the tie layer has a thickness of between 15 and 40% relative to the total thickness of the film.

17. The delamination-resistant ultrasonic sealant film according to claim 1, wherein the barrier layer is an oxygen barrier and consists essentially of polyamide.

18. The delamination-resistant ultrasonic sealant film according to claim 1, wherein the tie layer is adjacent to the sealant layer.

19. The delamination-resistant ultrasonic sealant film according to claim 1, wherein the film exhibits no delamination between the tie and barrier layers after the sealant layer is sealed to itself or a polyolefin substrate by ultrasonic energy to form a package.

20. The delamination-resistant ultrasonic sealant film according to claim 1, wherein the film is suitable for hot-fill and/or retort packaging applications.
